(19) United States
(12) Patent Application Publication
(10) Pub. No.: US 2016/0167395 A1
(43) Pub. Date: Jun. 16, 2016

(54) PLANT FOR MANUFACTURING AND PRINTING CONTAINER CLOSURE BODIES

(71) Applicant: SACMI IMOLA S.C., Imola (IT)

(72) Inventors: Danilo ALBONETTI, Imola (IT); Fiorenzo PARRINELLO, Medicina (IT); Dario BELTRANDI, Imola (IT)

(21) Appl. No.: 14/906,486

(22) PCT Filed: Jul. 23, 2014
(86) PCT No.: PCT/IB2014/063351

§ 371 Date: Jan. 20, 2016

(30) Foreign Application Priority Data
Jul. 25, 2013 (IT) VR2013A000176

(51) Int. Cl. B41J 3/407; B41J 2/01

(52) U.S. Cl. CPC B41J 3/4073; B41J 2/01

(57) ABSTRACT

A plant for manufacturing and printing cup-shaped bodies having an apparatus for manufacturing cup-shaped bodies that includes at least one portion made of plastics and a device for positioning the cup-shaped bodies manufactured by the apparatus on a transfer device that can move along a longitudinal transfer direction. The cup-shaped bodies rest with their lower edge on a resting surface that is defined by the transfer device with its concavity directed toward the resting surface. The plant includes, along the extension of the longitudinal transfer direction, a device for the digital printing of the cup-shaped bodies, and a component for controlling the position of the top edge of the cup-shaped bodies on the resting surface, the component being connected to the digital printing device.

### TECHNICAL FIELD

The disclosure relates to a plant for manufacturing and printing cup-shaped bodies on a transfer device that can move along a longitudinal transfer direction.

### BACKGROUND

Plants for manufacturing and printing container closure bodies, such as stoppers, capsules, bowls, cups, et cetera, are known and widely used.

Traditionally, stoppers made of plastics intended to close containers are printed by means of printing rollers or pads.

Stoppers made of plastics are generally manufactured by means of a pressure molding process or by means of injection molding.

In the first case, in output from the pressure molding apparatus, the stoppers are deposited, still hot, so that their head rests on a belt that transfers them toward a storage unit.

If the stoppers are manufactured by injection, the groups of stoppers are instead unloaded from the mold randomly inside storage containers, from which they are then removed, once cooled, to send them to the subsequent stations.

If the manufactured stoppers have to undergo a printing process, they are taken from the storage unit or from the storage container to be fed to a belt or chain that supports pins, also known as flights, on which the stoppers to be printed are fitted.

The belt then conveys the stoppers toward a printing station, which is constituted, for example, by printing rollers or pads that make contact with the upper surface of the stopper.

The solution described above obviously suffers many drawbacks.

First of all, the stopper, during the printing operations, is subjected to a rather high pressure by the printing device (be it a printing roller or a pad), and, therefore, it is not possible to print on the stoppers right after their production, since they have not yet achieved complete solidification and stability, but it is necessary to wait a few hours after their formation before sending them to the printing apparatus.

In particular, as regards container closure bodies, they are made typically of polymeric materials such as polypropylene (PP), high-density polyethylene (HDPE), or polymers thereof in these cases, the temperature of the bodies in output from the molding apparatuses is significantly higher than the ambient temperature and can vary between 40° C. and 90° C. for polypropylene stoppers and between 40° C. and 80° C. for high-density polyethylene stoppers.

This indeed creates the need to provide a cooling and storage unit, and accordingly, means for feeding the freshly formed stoppers to the cooling and storage unit and means for taking the cooled stoppers from the cooling and storage unit to send them to the printing apparatus.

Moreover, it is noted that from a constructive standpoint it is particularly complicated to fit the stoppers to be printed onto the pins supported by the chain or by the wheel. Moreover, conventional apparatuses are scarcely flexible if one wishes to change the formats or the images to be printed, requiring replacement of the pins with others having a diameter that is suitable for the new format and of many other components, such as the printing rollers.

This problem currently is felt very strongly, since increasingly often users require extreme flexibility and frequent changes of format.

Finally, it is noted that traditional printing provides for heating by flaming of the surface of the closure bodies to be printed, in order to make the inks adhere better.

However, heating by flaming entails a degeneration of the chemical-physical characteristics of the closure bodies, with consequent degradation of the mechanical characteristics and therefore of the quality of the products.

The aim of the present disclosure is to eliminate or at least reduce drastically the drawbacks noted above.

### SUMMARY

Within this aim, the disclosure provides a plant for manufacturing and printing cup-shaped bodies that allows to change very rapidly the image to be printed.

The disclosure also provides a plant for manufacturing and printing cup-shaped bodies that can be used also to print bodies made of plastics such as stoppers while still hot.

This aim and others that will become apparent hereinafter are achieved by a plant for manufacturing and printing cup-shaped bodies .

### BRIEF DESCRIPTION OF THE DRAWINGS

Further characteristics and advantages of the disclosure will become apparent from the description of preferred but not exclusive embodiments of a plant for manufacturing and printing cup-shaped bodies according to the disclosure, illustrated by way of non-limiting example in the accompanying drawings, wherein:

FIG. 1 is a schematic side elevation view of a plant for manufacturing and printing cup-shaped bodies according to the disclosure;

FIG. 2 is a schematic top view of the plant shown in FIG. 1; and

FIG. 3 is a sectional view of the plant, taken along the plane of arrangement defined by the line III-III of FIG. 2.

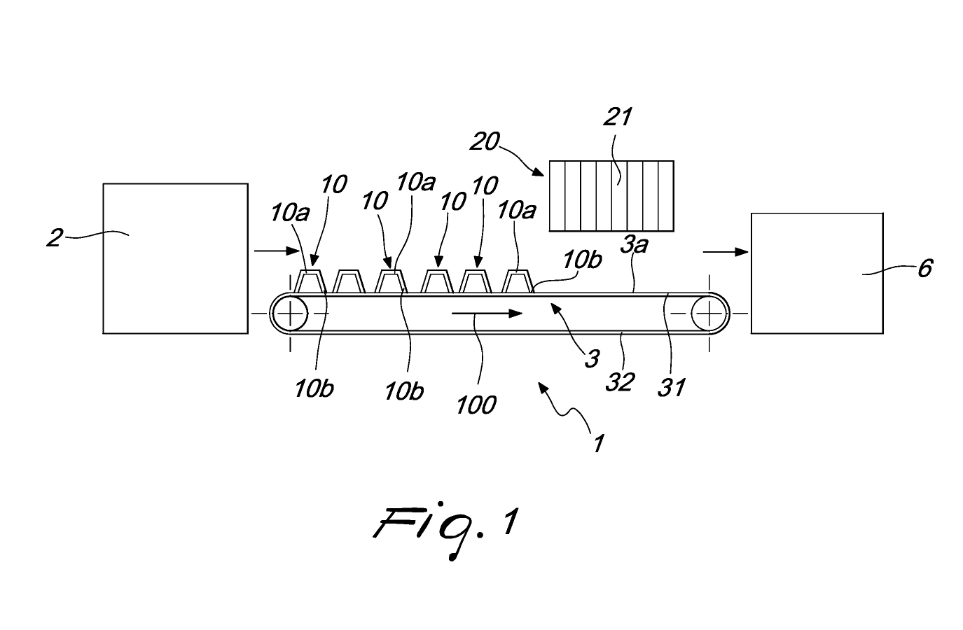

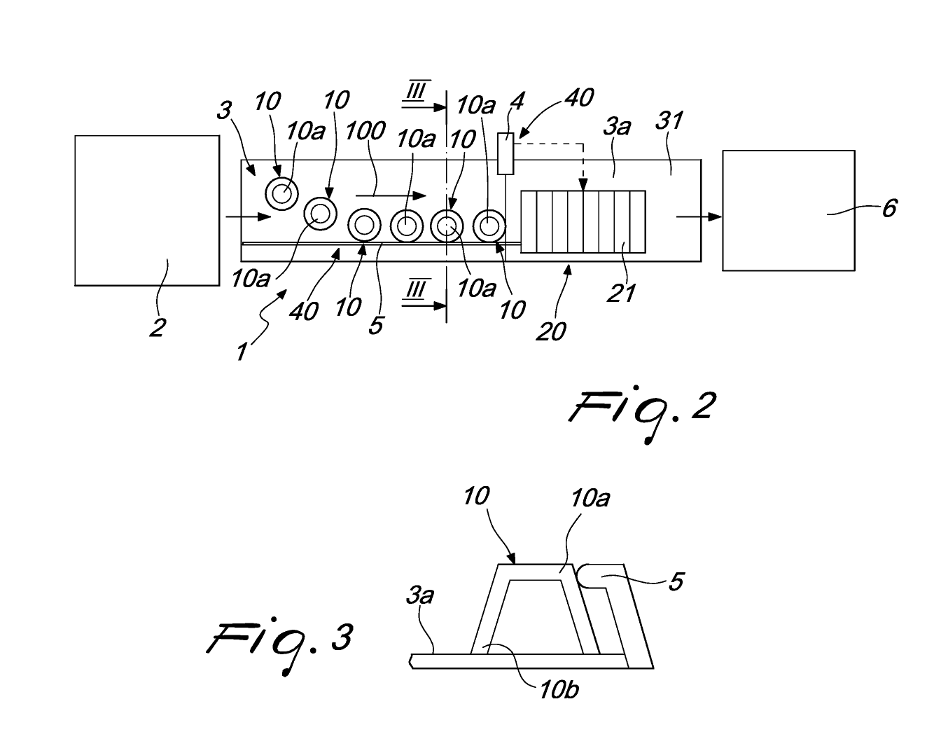

### DETAILED DESCRIPTION OF THE DRAWINGS

The present disclosure relates to a plant, generally designated by the reference numeral 1, for manufacturing and printing cup-shaped bodies such as stoppers, closure bodies, cups, bowls and the like.

Such cup-shaped bodies 10 comprise bodies that are at least partially made of plastics.

Advantageously, the cup-shaped bodies 10 comprise container closure bodies.

In particular, the cup-shaped bodies 10 can be constituted by bodies made of plastics or bodies made of metal that accommodate for example gaskets or sealing elements made of plastics.

The plant 1 comprises an apparatus 2 for manufacturing cup-shaped bodies 10 and a device for placing the cup-shaped bodies 10 manufactured by the apparatus 2 on a transfer device 3.

The cup-shaped bodies 10 can be sent to an intermediate storage unit and then taken from said intermediate storage unit by a placement device, in order to transfer them to the transfer device 3.

The intermediate storage unit can also comprise a long-term storage device: for example, the cup-shaped bodies 10 can be stored in Octabins or in bags to allow the feeding of the cup-shaped bodies 10 to the transfer device 3 even days, weeks or months after their manufacture.

The transfer device 3 can move along a longitudinal transfer direction, indicated by the arrow 100.

The cup-shaped bodies 10 rest on a resting surface 3a that is defined by the transfer device 3 with its concavity directed toward a resting surface 3a.

In particular, the cup-shaped bodies 10 rest with their free edge 10b on the resting surface 3a defined by the transfer device 3.

If the apparatus 2 is adapted to unload the cup-shaped bodies 10 with the respective concavity directed upwardly or randomly, the positioning device, which might be constituted by a manipulator, rotates the cup-shaped bodies 10 to bring the upper part (constituted by the outer surface that corresponds to the bottom of the cup) upwardly and rest a free edge 10b on the resting surface 3a.

Furthermore, the apparatus 1 comprises, along the extension of the longitudinal transfer direction 100, a device 20 for digital printing of the cup-shaped bodies 10.

There are also means 40 for controlling the position of the top edge 10a of the cup-shaped bodies 10 on the resting surface 3a: the control means 40 are functionally connected to the digital printing device 20.

It is in fact noted that the top edge 10a of the cup-shaped bodies 10, especially if hot, is the portion that has the most regular shape and is also significantly more rigid than the remaining part of the outer lateral surface of the cup-shaped body 10.

Preferably, the cup-shaped bodies 10 that rest on the resting surface 3a have at least partially a temperature that is higher than the ambient temperature and in many cases a temperature above 40° C.

For this reason, along the extension of the transfer device 3 there can be means for heating the cup-shaped bodies 10.

Said heating means are intended to heat at least the region of the cup-shaped bodies 10 that is intended for printing, in order to bring it to a temperature above 40° C. and preferably above 45° C. but in any case lower than the boiling point of the inks used by the digital printing device 20.

The apparatus 2 for manufacturing cup-shaped bodies 10 can be constituted by a pressure molding assembly or by an injection molding assembly.

If the apparatus 2 is constituted by a pressure molding assembly, the device for unloading the cup-shaped bodies 10 manufactured by the assembly is adapted to place in a substantially ordered manner and resting on the lower edge 10b, the cup-shaped bodies 10 manufactured directly on the resting surface 3a.

Obviously, it is possible to provide an intermediate storage unit arranged between the pressure molding assembly and the transfer device 3.

If instead the apparatus 2 is constituted by an injection molding assembly, it is necessary to provide a grip and placement device intended to pick up the manufactured and unloaded cup-shaped bodies 10, optionally in an intermediate storage unit, from the injection molding assembly and to deposit them in a substantially ordered manner and resting on the lower edge 10b on the resting surface 3a.

Advantageously, the transfer device 3 comprises a conveyor belt that has a closed shape and defines an advancement portion 31 and a return portion 32.

Specifically, the resting surface 3a is defined by the surface of the conveyor belt that is directed outwardly and advantageously upwardly along the advancement portion 31.

The conveyor belt is associated advantageously with a device for controlling its movement and its speed along the longitudinal transfer direction 100.

Such speed must be extremely uniform and constant to allow perfect registration in the application of the colors by the digital printing device 20.

The means 40 for controlling the position of the top edge 10a of the cup-shaped bodies 10 on the resting surface 3a comprise at least one sensor 4, which is adapted to detect the position of the top edge 10a of the cup-shaped bodies 10 that rest on the resting surface 3 and arrive toward the digital printing device 20.

The sensor 4 is connected functionally to the digital printing device 20.

The means 40 for controlling the position of the top edge 10a of the cup-shaped bodies 10 on the resting surface 3a can also be constituted by at least one longitudinal abutment 5 that extends parallel to the longitudinal transfer direction 100.

Specifically, the longitudinal abutment 5 is intended to make contact with the top portion 10a of the cup-shaped bodies 10 that arrive toward the digital printing device 20 and to arrange the cup-shaped bodies 10 rested on the resting surface 3a in a transverse position that corresponds to the transverse position of action of the digital printing device 20.

Conveniently, the sensor 4 is adapted to detect the position along the longitudinal transfer direction 100 of the cup-shaped bodies 10 that in each instance arrive toward the digital printing device 20.

The digital printing device 20 comprises at least one inkjet printing device 21.

Conveniently, the inkjet printing device 21 has four heads.

If covering of the surface to be printed of the cup-shaped body 10 is required, for example by means of the color white, the digital printing device 20 can comprise an additional printing station arranged upstream of the inkjet to printing device 21 along the longitudinal transfer direction 100.

Downstream of the inkjet printing device 21 and optionally of the additional printing station there can be, respectively, a first device and a second device for irradiating the printed surface.

The first and/or second irradiation device can be constituted by lamps is of the UV LED type that produce an immediate cross-linking of the inks; such lamps, in particular, have extremely limited space occupations and do not produce excessive heat.

Specifically, the second irradiation device is intended to produce the cross-linking of any white ink deposited by the additional printing station, while the first irradiation device produces the cross-liking of the colors deposited by the inkjet printing device 21.

To increase the printing speed, it is possible to install two or more print heads for each individual color.

Upstream of the printing device 20 it is possible to provide a station for the surface treatment of the cup-shaped bodies 10. Said surface treatment station can be of the corona and/or plasma type and has the purpose of oxidizing the surface so as to increase the adhesion of the inks.

Preferably, the surface treatment station is adapted to perform on the cup-shaped body 10 both a treatment of the plasma type and a treatment of the corona type.

Advantageously, the surface treatment station is adapted to perform on the cup-shaped body 10 a treatment of the plasma type and, in rapid succession, a treatment of the corona type.

In particular, it has been found that these surface treatments allow to ensure optimum adhesion of the inks even if the cup-shaped bodies 10, specifically the closure bodies, have traces or films of lubricant.

It is in fact observed that sometimes the cup-shaped bodies 10 contain up to 2000-5000 ppm of lubricant (for example erucamide or benamide).

In many cases the lubricant is distributed on the entire outer surface of the cup-shaped body 10 and, in particular, also at the region that must be printed.

Adhesion of the inks, especially if inkjet printing devices are used, is particularly difficult, since the ink is deposited without any pressure or mechanical action.

It has been found that in order to ensure adhesion of the inks, wettability is fundamental and so is adhesion of the ink directly on the surface of the cup-shaped body 10 and not on the lubricant.

Therefore, it has been observed that it is fundamental to eliminate the lubricant.

It has been found that the use of a surface treatment station of the plasma type and of the corona type allows to eliminate the traces of lubricant, increasing wettability and surface tension and accordingly increasing significantly the adhesion of the inks.

It has been found, moreover, that it is extremely advantageous to perform the surface treatment of the plasma and corona type on cup-shaped bodies 10 (or on portions thereof) at a temperature that is higher than the ambient temperature and, preferably, at a temperature above 40° C. or, even more preferably, above 45° C.

In fact, in the case of the plasma and corona treatment, the plasma ablates the lubricant (and also oxidizes it), in practice sublimating the lubricant or the byproducts of lubricant oxidation.

The plasma treatment also begins a first oxidative treatment of the surface of the cup-shaped body 10, while the corona treatment completes the surface treatment with the oxidation of the surface, with a consequent increase in the surface tension of the cup-shaped body 10.

It has also been found that the heating of the cup-shaped body 10 allows to accelerate the surface treatment process.

It has in fact been found experimentally that when cup-shaped bodies 10 that are heated or in any case at a temperature higher than 40° C., and preferably higher than 45° C., are fed to the surface treatment station, a significant increase in adhesion of the inks is achieved, since:
it increases the rate of the oxidative processes;
lubricant ablation is quicker, since the sublimation temperatures of the lubricant or of its oxidative byproducts are also reached more easily.

Downstream of the inkjet printing device 21 it is possible to provide an unloading storage unit 6.

Downstream of the digital printing device 20 it is furthermore possible to provide a device for checking the printed images, constituted for example by a viewer or a camera.

Operation of a plant 1 for manufacturing and printing cup-shaped bodies 10 is evident from what has been described above.

In particular, the apparatus 2 provides the cup-shaped bodies 10, which are rested, optionally still hot, in a substantially ordered manner, with their lower edge 10b on the resting surface 3a.

If there is an intermediate storage unit, the cup-shaped bodies 10 are taken from it and rested on the resting surface 3a.

The resting surface 3a is moved along the longitudinal transfer direction 100 to move the cup-shaped bodies 10 toward the digital printing device 20.

Preferably, if the cup-shaped bodies 10 are at ambient temperature, they are heated by the heating means to bring them to a temperature that is higher than the ambient temperature and advantageously higher than 40° C.

Before arriving at the digital printing device 20, the cup-shaped bodies 10 move at a surface treatment station to perform a treatment of the plasma type and, in rapid succession, a treatment of the corona type.

While the cup-shaped bodies 10 are conveyed by the resting surface 3a along the longitudinal transfer direction 100, they are made to make contact against the longitudinal abutment 5, so that all the cup-shaped bodies 10 that arrive toward the digital printing device 20 are arranged, in a transverse direction, exactly at the region of action of the digital printing device 20.

The sensor 4, arranged upstream of the digital printing device 20, detects the position, along the longitudinal movement direction 100, of the top edge 10a of the cup-shaped bodies 10 in order to actuate the digital printing device 20 as a function of the advancement speed of the resting surface 30 along the longitudinal movement direction 100.

All the characteristics of the disclosure indicated above as advantageous, convenient or the like may also be omitted or be replaced with equivalents.

The individual characteristics presented with reference to general teachings or to particular embodiments may all be present in other embodiments or may replace characteristics in these embodiments.

The disclosure thus conceived is susceptible of numerous modifications and variations.

In practice, the materials used, so long as they are compatible with the specific use, as well as the shapes and dimensions, may be any according to requirements.

All the details may further be replaced with other technically equivalent elements.

The disclosures in Italian Patent Application no. VR2013A000176, from which this application claims priority, are incorporated herein by reference.

1-20. (canceled)

21. A plant for manufacturing and printing cup-shaped bodies, comprising an apparatus for manufacturing cup-shaped bodies comprising at least a portion made of plastics, a device for positioning said cup-shaped bodies manufactured by said apparatus on a transfer device that can move along a longitudinal transfer direction, said cup-shaped bodies resting with their lower edge on a resting surface that is defined by said transfer device with its concavity directed toward said resting surface, said plant comprising, along the extension of said longitudinal transfer direction, a digital printing device configured for digital printing of said cup-shaped bodies, means being provided for controlling the position of a top edge of said cup-shaped bodies on said resting surface, said control means being connected functionally to the digital printing device.

22. The plant according to claim 21, wherein said cup-shaped bodies rested on said resting surface have at least partially a temperature that is higher than the ambient temperature.

23. The plant according to claim 21, further comprising, upstream of said digital printing device, means for heating the cup-shaped bodies configured to heat at least a region of the cup-shaped bodies configured for printing, in order to bring it to a temperature above 40° C. and lower than a boiling point of inks used by said digital printing device.

24. The plant according to claim 21, further comprising, upstream of said digital printing station, a station for a surface treatment of the cup-shaped bodies configured to perform a treatment of the corona type or of the plasma type.

25. The plant according to claim 24, wherein said station for surface treatment of the cup-shaped bodies configured to perform a treatment of the plasma type and of the corona type.

26. The plant according to claim 25, wherein said station for surface treatment of the bodies configured to perform, in rapid succession, a treatment of the plasma type and of the corona type.

27. The plant according to claim 25, wherein said station for surface treatment of the cup-shaped bodies configured to perform a treatment of the plasma type and of the corona type is adapted to reduce or eliminate the presence of lubricant at a region to be printed, increasing a surface tension and consequently an adhesion of the inks.

28. The plant according to claim 23, wherein said means for heating the cup-shaped bodies configured to heat at least the region of the cup-shaped bodies that is configured for printing, in order to bring it to a temperature above 40° C., are adapted to accelerate the surface treatment process performed by said surface treatment station.

29. The plant according to claim 21, wherein said cup-shaped bodies comprise a made of plastics body.

30. The plant according to claim 21, wherein said apparatus for manufacturing cup-shaped bodies comprises a pressure molding assembly or an injection molding assembly.

31. The plant according to claim 21, wherein said cup-shaped bodies are selected in the group comprising:
a stopper;
a container closure body;
a cup;
a bowl;
and the like.

32. The plant according to claim 21, wherein said transfer device comprises a conveyor belt that has a closed extension and defines an advancement portion and a return portion, said resting surface being defined by the surface of said conveyor belt that is directed outwardly along said advancement portion.

33. The plant according to claim 21, wherein said means for controlling the position of the top edge of said cup-shaped bodies on said resting surface comprise at least one sensor adapted to detect the position of the top edge of the cup-shaped bodies that rest on said resting surface to control said digital printing device.

34. The plant according to claim 21, wherein said means for controlling the position of the top edge of said cup-shaped bodies on said resting surface comprise at least one longitudinal abutment, which is extended substantially parallel to said longitudinal transfer direction, configured to arrange said cup-shaped bodies rested on said resting surface in a transverse position that corresponds to a transverse position of action of said digital printing device.

35. The plant according to claim 33, wherein said at least one sensor is adapted to detect the position along the longitudinal transfer direction of said cup-shaped bodies that approach in each instance said digital printing device.

36. The plant according to claim 32, wherein said conveyor belt is associated with a device for controlling a movement thereof and a speed thereof along said longitudinal transfer direction in order to ensure perfect registration in the application of the colors by said digital printing device.

37. The plant according to claim 21, wherein said digital printing device comprises an additional printing station arranged upstream of an inkjet printing device along said longitudinal transfer direction.

38. The plant according to claim 37, wherein said digital printing device comprises, downstream of said inkjet printing device along said longitudinal transfer direction, a first device for irradiating the printed surface, which comprises lamps of the UV LED type adapted to produce a cross-linking of the inks deposited by said inkjet printing device.

39. The plant according to claim 38, wherein said digital printing device comprises, downstream of said additional printing device along said longitudinal transfer direction, a second device for irradiating the printed surface, which comprises lamps of the UV LED type adapted to produce a cross-linking of the inks.

40. The plant according to claim 21, wherein said digital printing device comprises at least two print heads for each individual color.
